(19) United States
(12) Patent Application Publication
(10) Pub. No.: US 2012/0301584 A1
(43) Pub. Date: Nov. 29, 2012

(54) METHOD FOR ENHANCING AND OPTIMIZING CREATIVE VISUALIZATION AND MEDITATION TECHNIQUES

(76) Inventor: Sabina Ruth Cohen, Brooklyn, NY (US)

(21) Appl. No.: 13/479,840

(22) Filed: May 24, 2012

Related U.S. Application Data
(60) Provisional application No. 61/519,671, filed on May 26, 2011.

(51) Int. Cl. G09B 1/40; A23L 1/48

(52) U.S. Cl. 426/383

(57) ABSTRACT

This is a method for enhancing and optimizing creative visualization and meditation techniques by writing or engraving letters, which spell out words or phrases, on solvent, edible material in an aesthetic way, and then dissolving the letters made of edible material into edible liquids which are to be consumed by a person. Alternatively, the letters are dissolved into body care liquids, such as lotions or perfumes, to be applied to the person's body. The letters spell out words and phrases that the person wants to visualize. Consumption of the beverage into which words or phrases have been dissolved, or spreading onto the body of a lotion or perfume into which words or phrases have been dissolved, helps the person visualize the words and phrases

This invention claims benefit of the filing date of provisional application No. 61/519,671.

### FIELD OF THE INVENTION

This invention relates to a method of enhancing creative visualization, positive thinking and meditation by dissolving letters, which spell out words and phrases, into liquids and then applying them onto or ingesting them into the body.

### BACKGROUND

When a person's health is compromised, doctors say that positive thinking, a happy attitude, and a strong belief that one can overcome a medical condition may help the patient in achieving that goal. The inventor has studied methods to increase positive thinking and bring it into actuality through verbalization. In doing so, the inventor has succeeded in creating an enhanced positive atmosphere for herself and the people around her. In the process of creating and combining all-natural herbal tea mixtures and body oils, the inventor was searching for an ingredient(s) to add to such mixtures in order to make them uniquely appealing to others: to put a smile on people's faces, make them feel good, build self-image and encourage their positive thinking. The inventor devised the idea of using words, messages or symbols; printing them with solvent substances; and allowing them to melt or dissolve into the mixtures to be used.

The printed words, once dissolved, become part of the drink or body oil's ingredients. The drink or oil then carries dissolved words or messages into the physical body. Rather than just read or listen to the words using the senses of sight or hearing, the consumer actually perceives and utilizes the words with the senses of taste, touch and smell. By consuming the words internally or through the skin (the body's largest organ), they become part of the body. Rather than just speak words TO the body, the words are now “spoken” INTO the body. This is a new and unique concept.

Research indicates that positive change has occurred in the growth of plants when positive words are introduced into their atmosphere. Similarly other research by Dr. Masaru Emoto found that the molecular structure of water is influenced by spoken words. Positive words create beautiful symmetrical molecular structures. Negative words create unaesthetic asymmetrical molecular structures. The fact that a significant portion of the human body is water—averaging 60 percent of the total body weight—renders it a perfect target to “speak” to.

The free Online dictionary definition for ‘placebo effect’ is: 1. A substance containing no medication and prescribed or given to reinforced a patient's expectation. 2. Something of no intrinsic remedial value that is used to appease or reassure another.

The New York Times magazine, in an article published on Jun. 21, 2010, states: “Increasingly, placebo effects are being viewed as real and tangible, if mysterious. In various surveys, 45 percent to 85 percent of American and European practitioners say they have used placebos in clinical practice, and 96 percent of academic physicians in the United States say they think placebos have therapeutic effects.”

In the inventor's opinion and experience, a placebo effect is created while consuming the words utilizing the method described herein. Through the method described herein, the placebo effect of “consuming” words, messages and symbols further promotes positive thinking. Words, symbols and phrases are dissolved into edible liquids which are ingested, or into oils, lotions or perfumes to be applied on the body. The liquid into which words, symbols or phrases is dissolved could be an ingredient for a solid food, such as bread. In this way the words can be visualized by a user as becoming part of a drink, food, lotion, oil or perfume, and then carrying the message of those words into the person.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-1C depict words formed from the shapes of solvent letters implementing one or more embodiments of the present invention.

FIGS. 2A-2C depict various connections between letters in accordance with an embodiment of the present invention.

FIGS. 3A-3B depict connection between letters using external material in accordance with an embodiment of the present invention. In FIG. 3A Hebrew letters are used, as may the letters of any language be used.

FIG. 4 depicts a package of letters in a bag implementing one or more embodiments of the present invention.

FIG. 5 depicts packaging capsules in accordance with an embodiment of the present invention.

FIGS. 6A-6C depict packaging of letters as game pieces in an embodiment of the present invention.

FIGS. 7A-7B depict using toys as a packaging technique in accordance with embodiments of the present invention.

FIG. 8 depicts letters, written in both Hebrew and English translation and transliteration, printed on microfilm which can be dissolved, in accordance with an embodiment of the present invention.

FIG. 9 depicts an additional packaging technique in accordance with an embodiment of the present invention whereby a user can select from available letters to then spell out the user's own chosen message.

FIG. 10 depicts another embodiment of the present invention whereby available letters are dropped by a user into a cup containing a beverage.

FIGS. 11A-11B depict bottles labeled to show what letters were already dissolved into beverages or liquids in accordance with the method of the present invention.

### SUMMARY OF THE INVENTION

In the method of this invention a user is aided in visualizing positive messages, as if they are being transferred to the body. Words are spelled and dissolved into edible liquid, or into oils, lotions, perfume and the like to be applied to the body. The solvent letters could be made of soluable items such as sugar, salt, flavorings, fragrances and food coloring.

### DETAILED DESCRIPTION

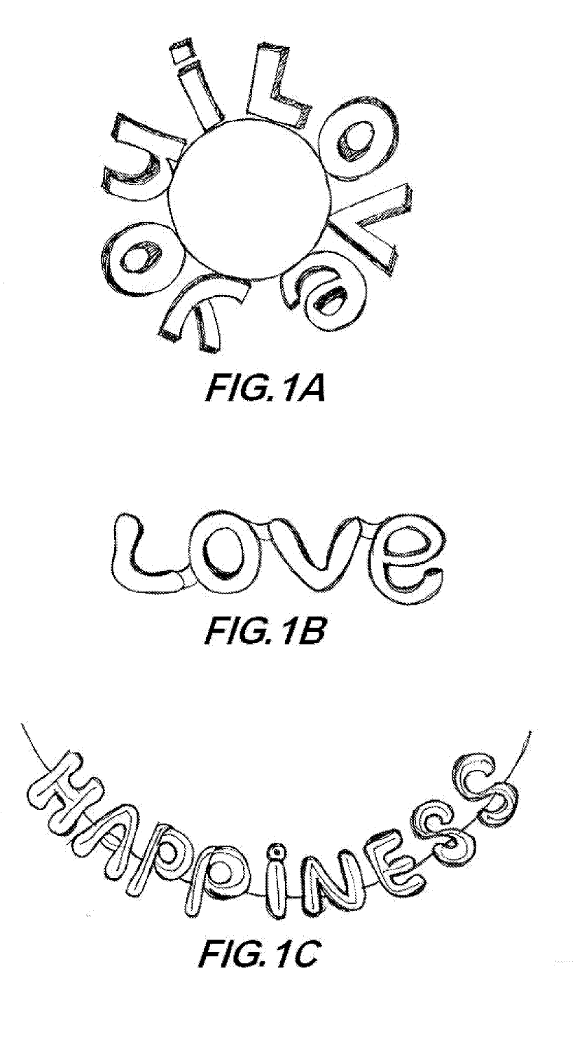

Reference is now made to FIGS. 1A-1C which depict a grouping of letters made of an edible material which can be dissolved. The letters are arranged in a variety of patterns like a circle, an arc or a straight line. Each figure contains one or more words). Other shapes, such as polygons for example, could also be used.

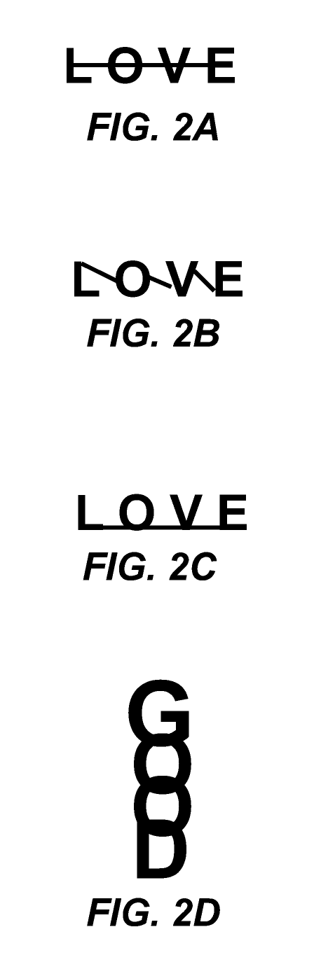

As illustrated in FIGS. 2A-2D, connection between the letters is achieved by adjoining the letters by different techniques. In this example the adjoining technique is done via more of the edible solvent material itself and the connection can be in a variety of ways. One connection is a straight line in the middle of the letters. Other connections are under the letters or a curved line between them. Chain linking of letters is also illustrated.

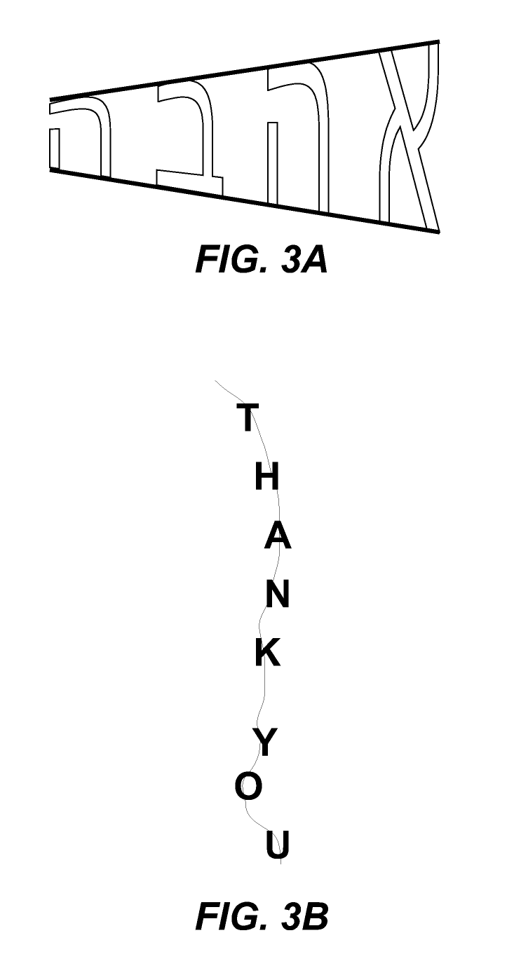

Other examples of letter and word adjoining techniques can be seen with respect to FIGS. 3A-3B. The adjoining techniques are made from external material other than the solvent such as a fiber. The adjoining technique can also be a non-soluable plastic frame that holds the letters.

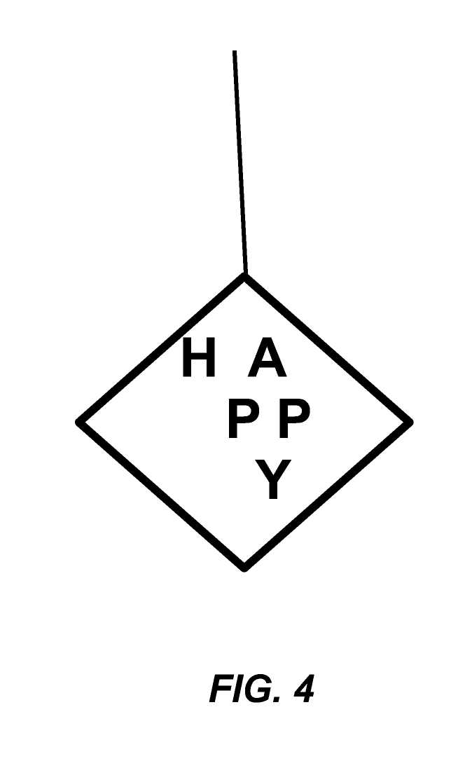

Reference is now made to FIG. 4 which depicts a packaging technique. The packaging technique can be a small bag in which the letters that make up the words are stored. Though not depicted, in the small bag there are holes like those in a tea bag. These holes allow the solvent to be dissolved into the liquid.

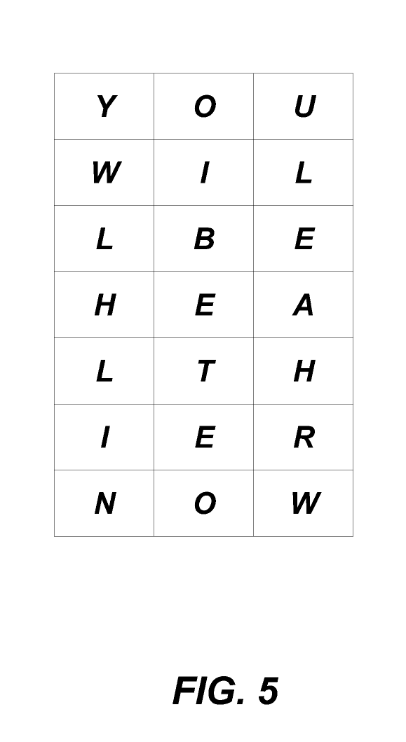

Another example of the packaging technique can be seen with respect to FIG. 5. In this figure a medicine is made into letters and then dissolved into a liquid. The arrangement of the letters in the pill box is a packaging technique. Each pill is shaped as a letter and all the letters make up a phrase. In the pill box illustrated in FIG. 5 the letters make up the phrase “you will be healthy now”.

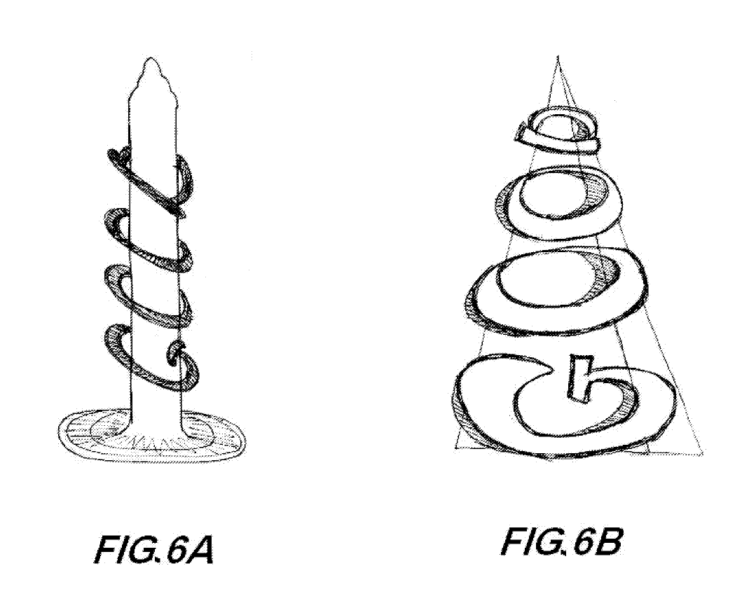

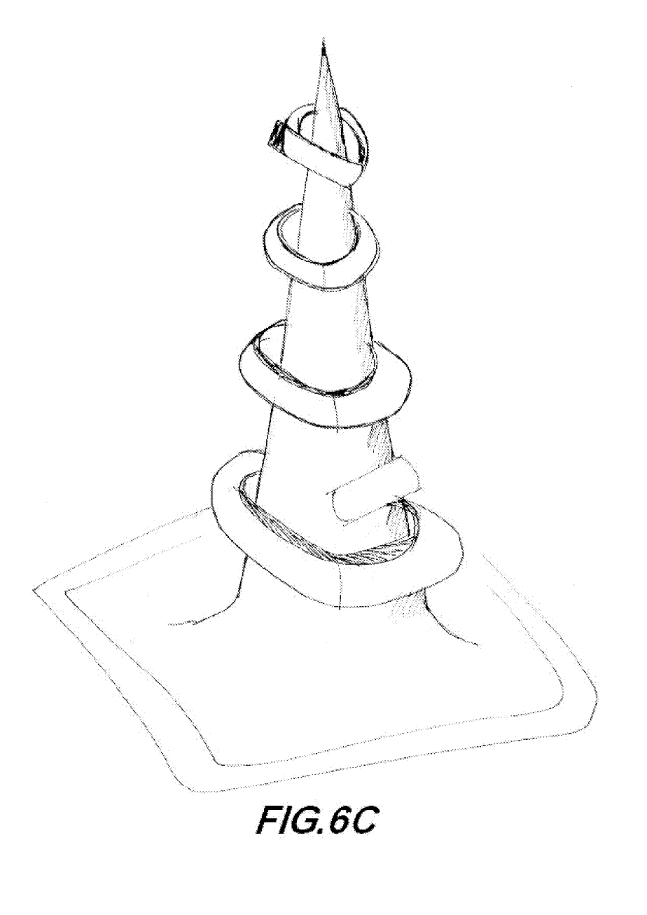

Reference is now made to FIGS. 6A-6B which depict pyramidal and cylindrical adjoining techniques. In a similar way FIG. 6C depicts a tower of Hanoi. The solvent materials in these examples are vitamins. These unique toys serve as connectors and are intended to encourage children to consume vitamins.

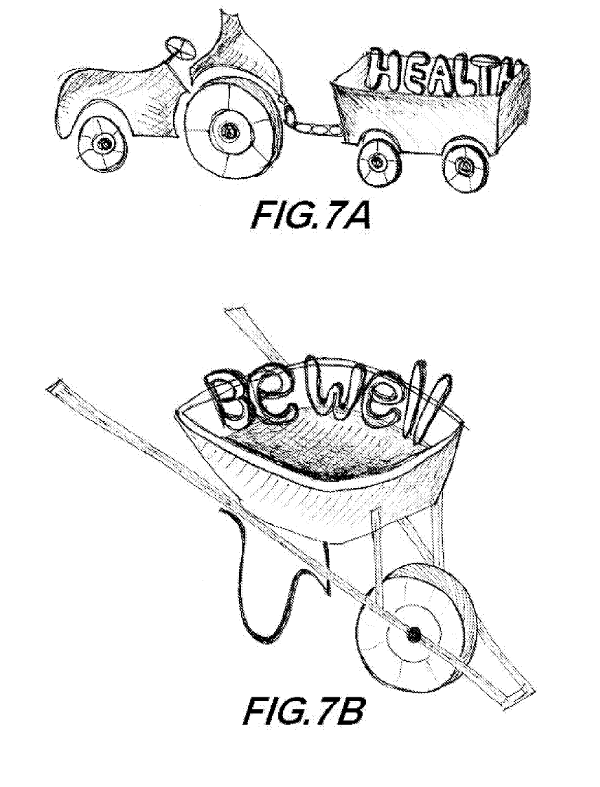

Another example of how the invention may be used is in connection with a toy packaging design as is illustrated in FIG. 7A. Vitamins or drugs are packaged in a tractor trailer in the form of letters that make up the word “HEALTH.” When a child finishes the vitamins he gets the toy. Similarly, FIG. 7B depicts a wheelbarrow with vitamins in it spelling the words “BE WELL.” The vitamin words can also be the name of the toy such as “tractor” and “trolley” and when the child finishes consuming the vitamins, he gets the toy represented by the word.

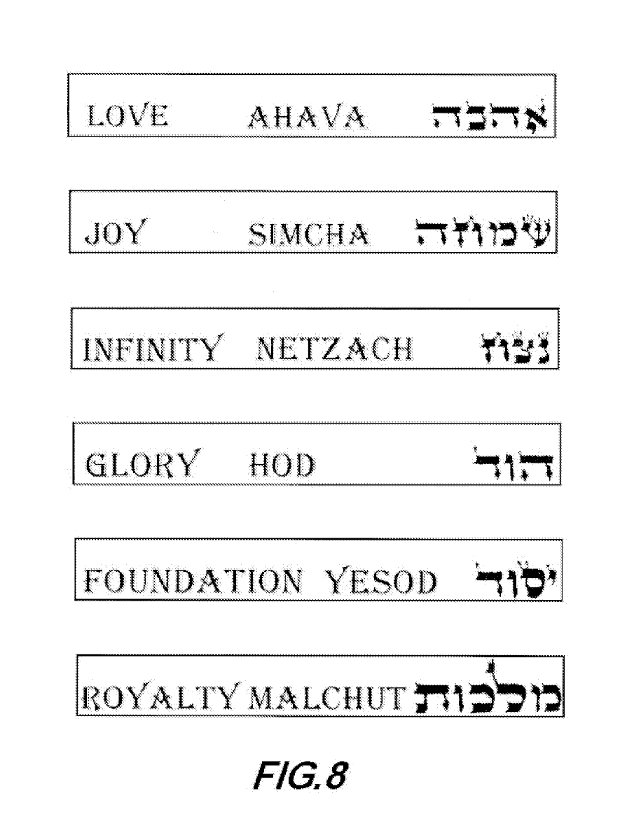

An example of the adjoining technique can be seen with respect to FIG. 8. The adjoining technique here is microfilm. Hebrew words are printed on it with their translation & pronunciation, which can be in any language. Some examples are “love”, “infinity” “royalty” or other positive words or messages. In this example the solvent is food coloring. Other adjoining items can be used such as wood, plastic, acrylic, or cardboard.

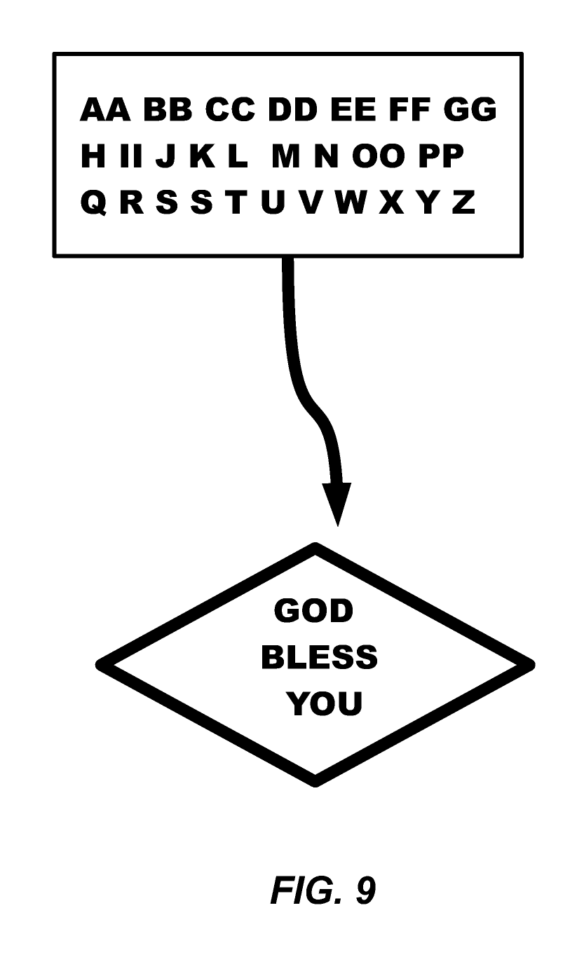

As illustrated in FIG. 9, in on embodiment of the method the user may receive a package that contains two of each of the alphabet letters and from them he can make up sentences such as: “GOD BLESS YOU.” In this example the user himself packages the letters into the perforated bag which builds the sentence.

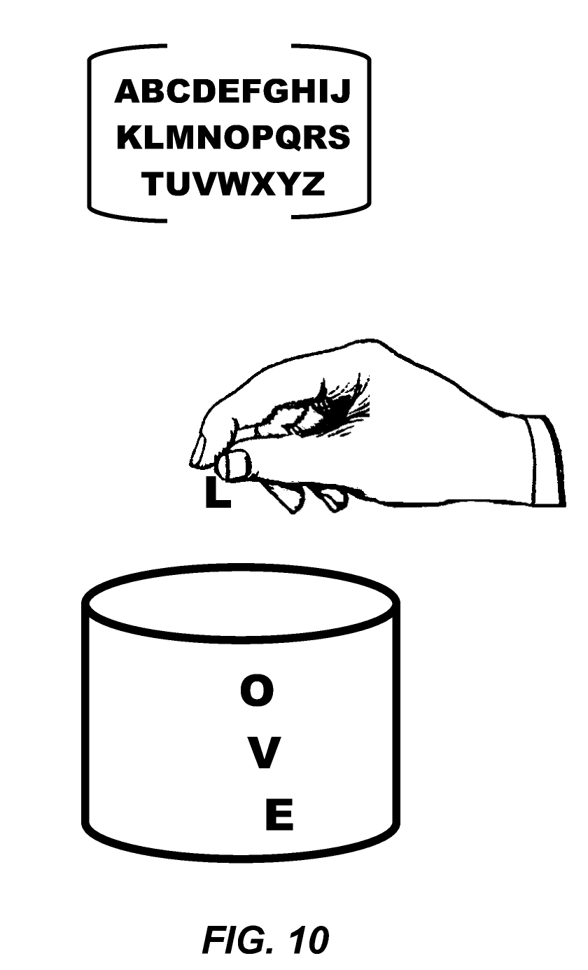

In the embodiment of the method shown in FIG. 10, the user receives a package that contains every letter of the alphabet and he individually selects the letters of a word, such as “LOVE” and dissolves them into the drink. This may be done by hand, either letter by letter or all together.

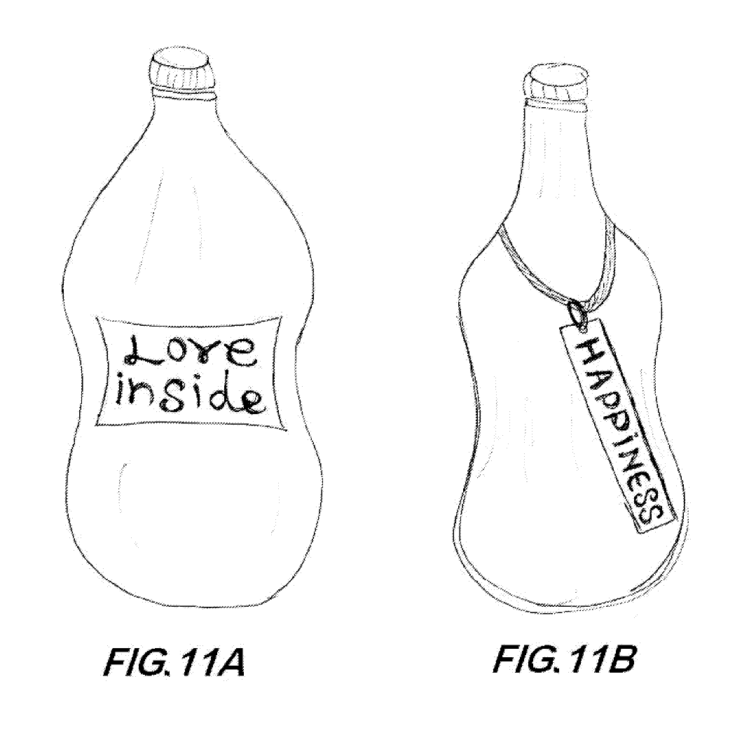

Reference is now made to FIG. 11A which depicts a drinking bottle on which “love inside” is written. In this embodiment of the method, the word “love” has been previously dissolved into the liquid on the bottling production line through the fill tank or liquid pool. The solvent that makes up the word may contain food coloring, flavoring and/or fragrance.

Reference is now made to FIG. 11B which depicts a drinking bottle with a stick hanging from a string attached to the bottle. The stick holds solvent letters which make up the word happiness. Solvents can be flavorings, fragrances or dyes. The user can then dissolve “happiness” into the bottle by inserting the stick into the bottle, which is filled with a liquid.

In another embodiment of the invention the method could be performed by writing words, phrases or symbols onto, or engraving them into, an edible film, which is then placed directly into a person's mouth, so that the letters dissolve directly in the person's mouth.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

I claim:

1. A method of promoting creative visualization and positive thinking by dissolving one or more edible letters or symbols into a liquid ingredient of a food, beverage or medicine to be consumed by a person.

2. The method of claim one wherein the letters are written on microfilm.

3. The method of claim one wherein the edible letters are written on a stick and then dissolved into the liquid ingredient.

4. The method of claim one wherein a phrase or message is spelled out with the letters.

5. The method of claim four wherein the phrase or message is created by adjoining the letters with an adjoining means.

6. The method of claim four wherein the phrase or message is created by connecting the letters by chaining them together.

7. The method of claim four wherein the letters are packaged together.

8. The method of claim four wherein the letters are placed in a capsule.

9. The method of claim four wherein the letters are selected by the person.

10. The method of claim four wherein the letters are packaged with toys.

11. The method of claim four wherein the letters are game pieces.

12. The method of claim 5 wherein the adjoining means is a fiber on which the letters are threaded.

13. The method of claim 5 wherein the adjoining means is bonding material.

14. The method of claim 7 wherein the letters are packaged together in a perforated bag.

15. The method of claim 7 wherein the letters are packaged together in a pill box.

16. A method of promoting creative visualization and positive thinking by dissolving one or more edible letters or symbols into a beverage to be consumed by a person.

17. A method of promoting creative visualization and positive thinking by dissolving one or more edible letters or symbols into a medicine to be consumed by a person.

18. A method of promoting creative visualization and positive thinking by dissolving one or more letters or symbols into a liquid body care product to be applied to a person's body.

19. A method of promoting creative visualization and positive thinking by dissolving one or more letters or symbols into a liquid ingredient of a body care product to be applied to a person's body.

20. A method of promoting creative visualization and positive thinking by writing letters, symbols or phrases on an edible film which is consumed by a person.
